(19) United States
(12) Patent Application Publication
(10) Pub. No.: US 2011/0131450 A1
(43) Pub. Date: Jun. 2, 2011

(54) USING SYNCHRONIZED EVENT TYPES FOR TESTING AN APPLICATION

(75) Inventors: Graham Wheeler, Redmond, WA (US); Frederic Mokren, Bellevue, WA (US); Fernando Zandona, Sammamish, WA (US); Danny Lange, Sammamish, WA (US); Joe Futty, Sammamish, WA (US)

(73) Assignee: Microsoft Corporation, Redmond, WA (US)

(21) Appl. No.: 12/626,949

(22) Filed: Nov. 30, 2009

(51) Int. Cl. G06F 11/07

(52) U.S. Cl. 714/32; 714/E11.024

(57) ABSTRACT

Embodiments are described for using synchronized event types in testing an application configured to be executed on multiple types of networked devices. The method can include playing a macro containing recorded application events to be applied to the application for testing. The recorded application events can be stored in a macro queue during playback. Further, order independent events can be identified in the macro queue, which precede an order dependent event. This enables identified order independent events to be removed. In addition, an order dependent event in the macro queue can be removed after order independent events preceding the order dependent events are removed. Then the order dependent event from the macro queue can be played after the order dependent event has been removed from the macro queue.

### BACKGROUND

Many types of mobile electronic devices exist which enable users to perform mobile tasks and communicate with others. Such mobile devices may include netbooks, internet appliances, mobile audio players (e.g. iPod Touch® devices), and mobile phones. Some mobile phones can be categorized as smart phones which have an operating system and applications can be downloaded onto the phone from a web portal. Another category of mobile phones is feature phones which have a limited set of features for telephone calls, address books, and picture taking, but software applications have not typically been downloaded onto these phones. Unfortunately, these feature phones are limited in the features provided to users.

More recently, a software application or client shell has been designed for mobile devices and feature phones to expand the capabilities of these devices, to deliver new functionality and services, and to provide a more desirable mobile experience. This type of client shell can include both client and server components. The client shell is a lightweight application that is designed to run on mobile devices or feature phones. The infrastructure components deployed by application partners within the client shell provide embedded applets powered by the client shell. The embedded applets are the application infrastructure components that are executed within the client shell.

Testing the client shell and the applet infrastructure components loaded into the client shell can be a challenging and time-consuming task. Macro automation can be used in order to speed-up the testing of the client shell and applets. Automation macros can be created using macro recording software to record a user's interactions with the client shell or applets and to create a macro containing these replayable sequences of key press events, mouse events, and other user interface events.

The testing challenge is increased by the large number of mobile devices upon which the client shell may be used. The client shell and applets may be configured to execute upon hundreds of unique mobile device types. This can make testing challenging due to a wide variety of events that may be received from a host network or mobile network by the mobile devices. In addition, the macro automation script for testing may be generated on a different mobile device than the device being tested.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various embodiments are described for using synchronized event types in testing an application configured to be executed on multiple types of networked devices. The method can include playing a macro containing recorded application events to be applied to the application for testing. The recorded application events can be stored in a macro queue during playback. Further, order independent events can be identified in the macro queue, which precede an order dependent event. This enables identified order independent events to be removed as the order independent events are received. In addition, an order dependent event in the macro queue can be removed after order independent events preceding the order dependent events are removed. Then the order dependent event from the macro queue can be played after the order dependent event has been removed from the macro queue.

### BRIEF DESCRIPTION OF THE DRAWINGS

FIG. 1 is a block diagram illustrating an embodiment of a system for testing an application used on networked devices.

FIG. 2 is an embodiment of a flowchart illustrating a method for recording macros used for testing an application used on the networked devices.

FIG. 3 is a flowchart illustrating an embodiment of a method for macro playback while testing an application used on networked devices.

FIG. 4 is a block diagram illustrating an embodiment of a macro queue with order independent events and order dependent events.

FIG. 5 is flowchart illustrating an embodiment of a method for testing an application configured to be executed on multiple networked device types.

### DETAILED DESCRIPTION

Reference will now be made to the exemplary embodiments illustrated in the drawings, and specific language will be used herein to describe the same. It will nevertheless be understood that no limitation of the scope of the technology is thereby intended. Alterations and further modifications of the features illustrated herein, and additional applications of the embodiments as illustrated herein, which would occur to one skilled in the relevant art and having possession of this disclosure, are to be considered within the scope of the description.

One way that an application can repeat past behavior is by using recorded user input (typically key presses and pointer type events) as macros, and the macros can be replayed on the application to repeat the recorded sequence of events. In the past, testing macros have typically been sequences of user interface (UI) events that are played back blindly by a macro playback engine, often using timestamps. This simplistic approach is less workable in the situation where the client devices being tested can have other event sources that are not under a user's control or the application tester's control. In many mobile device networks, the network requests and responses are controlled by the network owner and the network events vary by device type. In such an environment, the benefits of macro automation are desired in testing but a more sophisticated approach can be used to deal events which cannot typically be controlled from the testing side.

The present technology includes a testing system and method that can be applied to an application for a mobile device (e.g., an internet appliance or a mobile phone) connected to a computer network. The testing system and method is a useful testing tool when the application is configured to run on a large number of different device types.

The present technology records not only user-initiated user interface (UI) events but any other non-user initiated events too, such as timer events and network events. The non-user initiated events can be called order independent events. In contrast, the user-initiated events and synchronization events can be defined as order dependent events. Synchronization events are events which occur when a user interface changes, a macro script ends or another similar event occurs. The order independent events can be received and synchronized with the order dependent events (e.g., user events and script execution events) so the order dependent events (e.g., user events) occur when the application is in the appropriate application and network state. In addition, the stream of events can be optimized and compressed to reduce the size of the recorded macros during playback while retaining their fidelity.

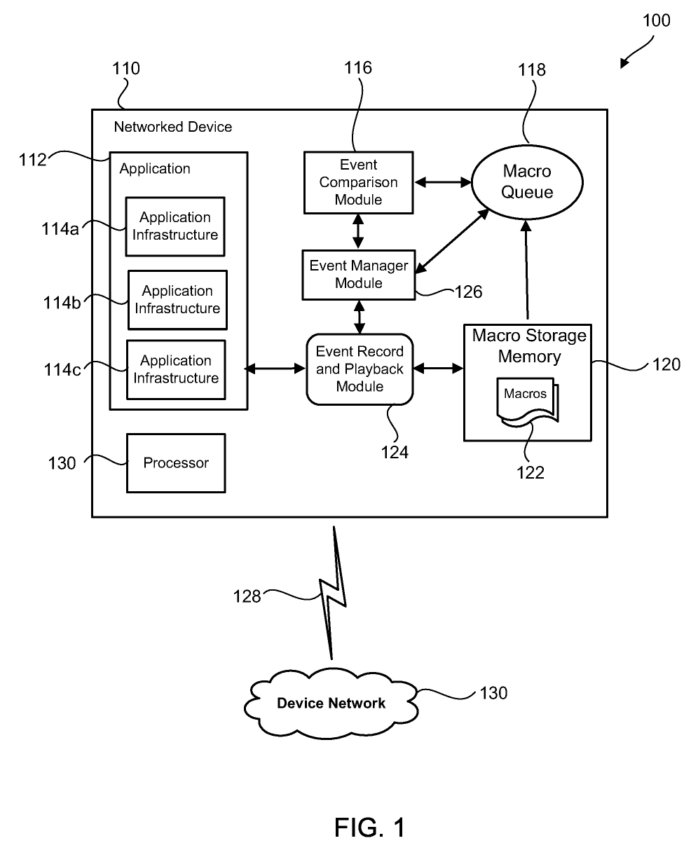

As illustrated in FIG. 1, a system 100 may be provided for testing an application 112 in an application environment for networked devices 110 or mobile devices. The application can be configured to load application infrastructure components 114a-c which are the portions of the embedded applets that will be executed for the user within the application. Independently executing applications can also be tested using the present technology. In addition, the networked device may be connected to a device network 130 via a wireless connection 128. While many mobile devices use a wireless connection, the connection to the device network may also be wired, if desired. Even though the networked device will frequently use a network, the device does not necessarily need to be networked constantly, since some parts of the applications or applets (e.g., executable code) may reside locally on the device and can operate when the device is not connected to the network.

The system can include a macro storage memory 120 configured to store one or more macros 122. The macro storage memory can be a RAM (Random Access Memory), Flash memory, hard drive, or another type of volatile and/or non-volatile memory. The macros can store recorded events which can be played back on the application 112 using a processor 130 when testing an executing application. The macros can be stored in a flat file, a database, or using another known macro storage format. Further, the macros may be stored in a computing and/or storage cloud accessible to the networked device via a network.

A macro queue 118 can be configured to store an ordered list of the recorded events from one or more macros 122 during playback of the macros. An event manager module 126 can be configured to receive order independent events, such as network and timer events, which affect to the application 112. The event manager can also receive synchronization events.

An event comparison module 116 can be provided to identify order independent events that have been received which precede an order dependent event in the macro queue. Order independent events can be defined as non-user events received from a network or events received from a mobile operating system for the mobile device. Order independent events are order independent as compared to other order independent events that precede an order dependent event. Order independent events are not necessarily order independent as compared to all other events or all order independent events in the macro queue. For example, the non-user events can be timer events, network events, image requests, and failure events received by the networked computing device 110 or mobile device. More detailed examples of network events include network connection events, network disconnection events, network acknowledgements, payload receipt events, and other known network events. Once these order independent events have been received, identified, and dispatched, then the order independent events can be removed from the macro queue.

The event comparison module 116 is further configured to identify when an order dependent event is at the head of the macro queue. An order dependent event can be a user-initiated event that is checked for at a head of the macro queue. The identified order dependent event or user-initiated event can then be played back on the application. The identified order dependent event from the macro queue can also be removed when identified.

Additionally, the event comparison module can be configured to identify an order dependent event that is located at in a body of the macro queue. The macro queue body is defined as being events that are located at the head or after the head of the queue. Typically, an order dependent event located in the macro queue body will be a synchronization event. An example of a synchronization event is a script execution event or a script start event. When a synchronization event is identified in the body of the macro queue, the order independent events (e.g., network events) preceding the identified order dependent event can all be removed. The synchronization events can be generated by the event record and playback module 124 or another module that controls the synchronization events.

An event record and playback module 124 can be provided to play the order dependent events back against the application. The events that are played back will generally be the recorded user-initiated events. The event record and playback module can also include event recording operations that enable the system to record macros that contain user interface events for the application. The event recording module can be configured to capture every event handled by an event handler on the networked device or mobile device for storage in a macro. For example, the event record and playback module can record a plurality of user input events and script synchronization events into a macro for later playback. In addition, other non-user events can be recorded into the macro such as timer events, network events, image retrieval events, and failure events.

It is valuable to record not just user-initiated events but other events that affect the state of the application. As a result, the system can block the playback of user-initiated events when playing back a macro until a matching sequence of non-user generated events is captured. This is more sophisticated and resilient than existing macro regression testing approaches that typically use just timestamps and playback events with the same delays as the originally recorded macro sequence. In the present technology, dependence on timestamps can be generally eliminated and replaced with a dependence on state, which is more robust. The dependence on state can enable the macros to be replayed at a higher speed than previous time stamped macros as dictated by the changing states of the networked or mobile device.

Additional aspects of the technology that will now be discussed. Specifically, a macro record process, a macro playback process, and an optimization process that executes as a subcomponent of the macro recorder will be described in more detail.

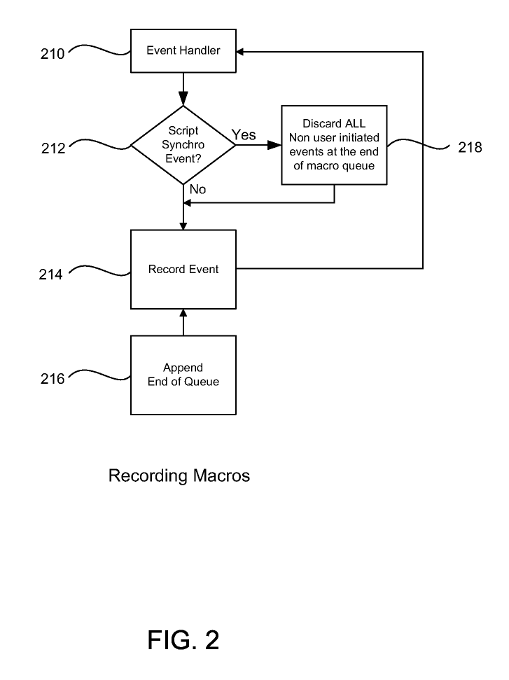

FIG. 2 is a flowchart illustrating a method for recording a macro for the present technology. When recording is enabled, the system records every event user-initiated event. However, there are other types of non-user initiated events that can occur, such as timer events, responses to network requests, and failure events. Each of these non-user initiated events (i.e., order independent events) will be handled by an event handler. Otherwise, the event is not relevant as no action is taken in response to the event. So, the system can record the execution of these event handlers interleaved with the user-initiated events (e.g., key presses, pointer movements) as they occur.

Initially, the event handler can trigger a message that an event has occurred 210. Alternatively, the event message can be identified before the event handler is activated. Next, the event will be checked to determine whether the event is a synchronization event 212. A synchronization event is an event can take precedence over other events after the synchronization event in the macro queue. Synchronization events are events that can represent general macro script transitions or script transitions related to UI transitions. A specific example of a synchronization event is a script execution or a script start event. Another example of a synchronization event may be a major user interface (UI) transition in the application (e.g., a window close event, menu load, etc.).

When the event is a script synchronization event, then any non-user initiated events after the script synchronization event at the end of the current queue may be discarded 218 or not recorded. This discarding of non-user initiated events is possible because recording of these non-user initiated events is not relevant to the application state at that point during testing due to synchronization transitions. Discarding irrelevant events also optimizes the size of the recorded macros. If the current event is not a script start event, then the event can be recorded in the macro 214. When no more events are received, then an end of queue or end of script message will be appended to the macro 216.

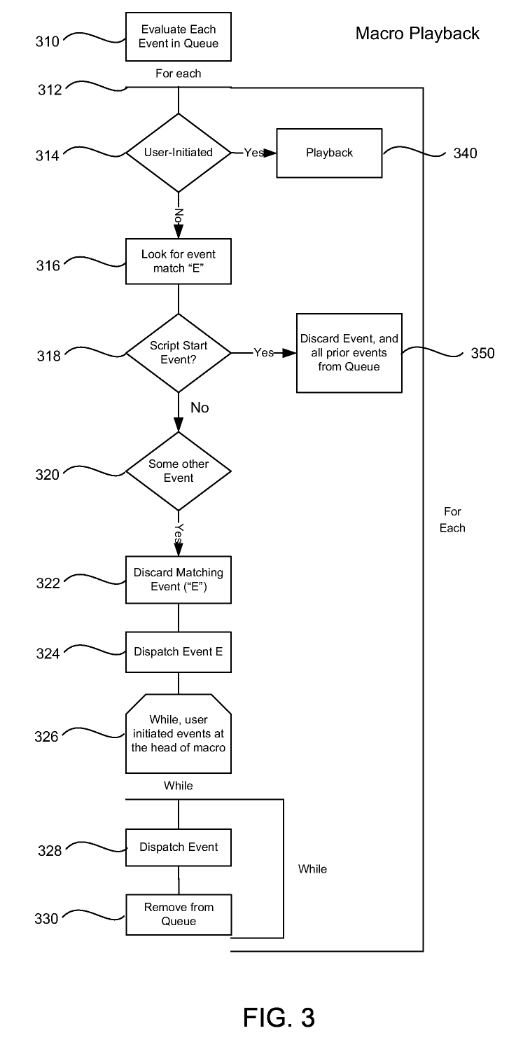

FIG. 3 illustrates an example embodiment of a macro playback method in the present technology. To playback the recorded macro sequence, the recorded macro is kept in a macro queue. As events are received, the events being received can be evaluated by comparison to the events in the macro queue 310. An evaluation happens for each event received for comparison to the macro queue 312. As event handlers fire, the head of the queue is checked for an event match. If the event at the head of the queue is a user-initiated event 314, that event is removed from the macro queue and the user event (e.g., key press) is played back on the application 340.

If the event is not a user-initiated event, then the system will try to find a match for the event 316. If the matched event is a synchronization event (e.g., script start event) 318, then the script start event and all the prior events in the macro queue will be discarded from the queue 350. If the event is a synchronization event, the synchronization event can be found by searching the macro queue from the beginning of the queue, but the search will not continue past a user-initiated event or a synchronization event.

If the incoming event is not a script start event, then the event will be checked to see if the event is some other type of event 320. If the event is another type of event such as a network event or another order independent event, then playback of the order dependent events can be blocked until the order independent event(s) are received to ensure a correct application state before the order dependent events are played back. Of course, the matching order independent event can then be discarded from the macro queue 322. Next, the matched event will be dispatched to be applied to the application 324 and/or system state.

The present technology then checks to see whether there are any further user-initiated events at the head of the macro queue 326. If there is a user-initiated event at the head of the macro queue, the user-initiated event will be dispatched 328 and applied to the application. Then the user-initiated event will be removed from the macro queue 330. This sub-processing for user-initiated events located at the macro queue head can be repeated as long as there are additional user-initiated events at the head of the macro queue. Otherwise, the steps described for FIG. 3 will be repeated from the beginning for the next event.

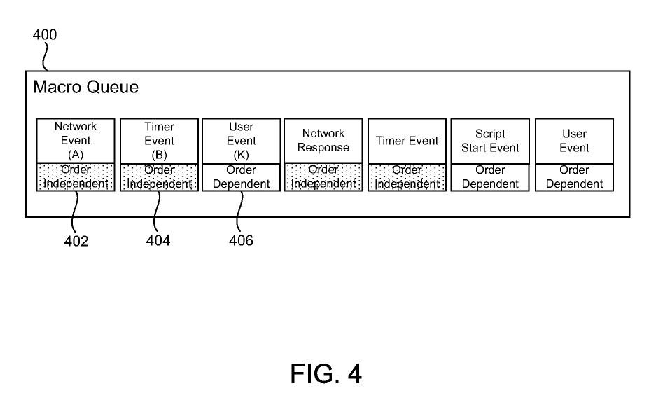

There can be some degree of non-determinism in the present system and method. When matching non-user initiated events, the system and method does not look at just the item at the head of the queue but the system examines all the non-user initiated events in the queue that come ahead of the first remaining user-initiated event in the macro queue. As illustrated in the example macro queue 400 of FIG. 4, if events A 402 and B 404 are non-user events and K 406 is a user-initiated key press event, then the non-user initiated events (e.g., network and timer events) compared against the queue ABK will match both AB and BA. Once both A and B have occurred and been matched in any order, then K will be replayed and applied to the application.

An additional operation configured to identify order independent events by type can assist in optimizing the playback of the macros. The stream of events described can become quite large. If several non-user initiated events occur between a pair of user-initiated events, such as the AB example above, the system may be able to discard some of these events from the recorded queue. For example, the system may determine that events of type A and B originate from different threads, and that the event of type A causes some change in the display but event B does not. In this case, the system can determine that the user originally pressed K when the user interface was in the post-A state, so it is important to wait for A to occur before replaying K, but it may not be important to wait for events of type B. Thus, the system may optimize the ABK sequence to just AK. The system may also be configured to identify threads which generate events affecting the user interface and threads that generate events which can be disregarded.

In another example embodiment describing a playback method of the technology, three different event categories may be described:
(A) events where order is unimportant such as non-user events (e.g., timer and network events),
(B) events where order is important and the event must be at head of queue to be dispatched (e.g. user-initiated events).
(C) events order is important and event need not be at head of queue (e.g. synchronization events such as script start events).

When playing a macro back for testing an application, a macro queue of recorded events is stored as a macro queue, and then some event (E) is received from the network or computing device. The system can then respond using the logic described below.

If the event (E) is a category A event where order is unimportant (i.e., an order independent event), then the system can look at all the category A events starting at the head of the queue and search down the macro queue for a match. If a match is found for a category A event, then the system can remove the matching event from the queue. In addition, the system can stop looking for a match when an event is reached in the macro queue that is not a category A event. In other words, a search for a category A event will not go past a category B or C event.

If the received event (E) is a category B event, such as a user-initiated event, the system will look at just the first event at the head of the macro queue. When a match is found, the user-initiated event will be removed from the queue, and the user-initiated event can be played back to test the application.

In the situation where the received event (E) is a category C event that is a synchronization event (e.g., a script execution event), the macro queue can be sequentially searched from the beginning of the queue for the first category B or C event in the queue. When an event in the macro queue matches the incoming event (E), the matching C event can be discarded from the macro queue. In addition, all of the category A events from the head of the queue which precede the matching C event can be discarded. It is helpful to note that the optimization step will typically have eliminated the preceding category A events from the queue already. In one configuration, the optimization is performed by removing as many category A events from the macro queue as possible before searching for the order independent events take place.

If no match is found for the event (E) being received, this means the optimization stage removed the matching category A event, or another category C playback removed the matching event. After all the above steps are completed, if the event at the head of the queue is a user-initiated category B event, the user-initiated event can be played back. This last step is repeated until no additional user-initiated events are at the head of the macro queue. The system then returns to receiving additional events.

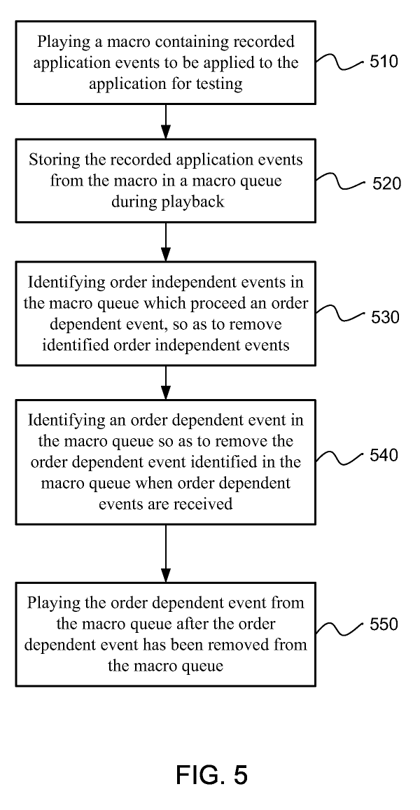

FIG. 5 illustrates a method for using synchronized event types in testing an application configured to be executed on multiple networked device types. The method can include the operation of playing a macro containing recorded application events to be applied to the application for testing, as in block 510. The macro will have been recorded prior to use and stored for playback in order to regression test the desired application. The recording of the macro may include recording every event handled by an event handler into the macro. This recorded macro can store a plurality of user input events, synchronization events, network events, and other events for later playback. Because these multiple types of events are stored, the event playback in the present technology can be state driven as opposed to time driven.

The recorded application events from the macro can be stored in a macro queue during playback, as in block 520. The playback of events contained in the macro can be used to test the desired application. Non-user initiated events, user dependent events and synchronization events can then be received by the application from the macro playback engine, network and the local hardware. The order independent events include events such as network events, operating system events, mobile device events, and similar events which may be received in any order. These received events can be applied to update the application state. The playback of the user-initiated macros can be blocked until the order independent events located at the beginning of the macro queue are received.

An order independent event in the macro queue can be identified, as in block 530. The order independent event identification or matching operation is limited to identifying events which precede an order dependent event (e.g. a user-initiated event or synchronization event). The order independent event can be a network event or hardware event on a networked device that does not involve user input. For example, the order independent events can be non-user initiated events including: timer events, network events, and failure events, as received by an application, networked device, or mobile device during the execution of the application.

Once the order independent event has been identified in the queue, then the event can be removed from the queue. This removal operation may occur for each of a plurality of order independent events received in any order as compared to events in the macro queue preceding an order dependent event (e.g. a user-defined interface action or script start event). Specifically, the timer events, failure events, network events, and other non-user initiated events can be removed from the macro queue when order independent events are received in any order by a networked device or mobile device.

A more detailed description of blocking processing that can occur while waiting for order independent events will now be provided. When all the events have been stored in the macro queue, then a separate thread may be used to process the macro queue. The process that handles an event can perform the macro synchronization before handling the event, and then perform playback afterwards. An example of the pseudo-code that may be used in an event handler with blocking is below:

handleEvent(E)
{

Perform any macro queue synchronization caused by event E

Perform processing for event E

While the head of the macro queue contains replayable events, replay them (e.g., put in the event queue)

}

An order dependent event can also be identified in the macro queue, as in block 540. The order dependent event can be a user-initiated event (i.e., a user dependent event) located at a head of the macro queue or a synchronization event located in the macro queue body. The order dependent event identified in the macro queue can be removed when order dependent events are received, and after order independent events preceding the order dependent event are removed.

A further operation is playing the order dependent event from the macro queue after the order dependent event has been removed from the macro queue, as in block 550. For example, the user-initiated event located at a head of the macro queue can be played back or a synchronization event (e.g., script execution event) can be dispatched. In the case of a script execution event, the macro queue body can be searched from the beginning of the macro queue in order to find and remove the user dependent event from the macro queue. Any remaining non-user initiated events that are still in the macro before the script execution event will be removed from the queue along with the synchronization event and this removal allows events to be in the script that may not be specific to every type of device the test is applied on. In other words, order independent events that are not found by the time a synchronization event is received will be cleaned out of the macro queue.

In some cases, there may be a received event that does not match an event in the macro queue. When no match is found, the unmatched event can be discarded because the event was not matched to an event in the macro queue. The reason for this lack of a match will generally be a result of the optimization stage for non-user initiated events or the result of a script execution playback event having already removed the event.

The synchronization operations described can also be understood in the following pseudocode description. Specifically, this pseudocode below might be used for the synchronization step of the HandleEvent pseudo code described above.

```
Synchronize(Evt)
{
  if (at end of macro queue)
    Stop macro playback
  else
  {
    Set p = last_macro_position
    Set gotNonNull = false
    while (p < macro queue length)
    {
      Let e = macro_queue[p]
      If (e is playable)
      {
        If (gotNonNull == false)
        {
            Set last_macro_position = p // advance
to this playable event as we have only nullified events preceding it
        }
        return; // done with sync
      }
      else if (Evt is a script run event)
        {
          Set macro_queue[p] = undefined;
          If (e is a matching script run event)
          {
            Set last_macro_position = p + 1;
            return; // done with sync
          }
      }
      else if (e is not undefined)
      {
        If (Evt matches e)
          {
            Set macro_queue[p] = undefined
            If (last_macro_pos == p)
              set last_macro_pos = p+1;
            return; // done with sync
        }
        Set gotNonNull = true;
      }
    }
    Set p = p + 1;
  }
}
```

### Example Application

While the technology described may be useful in testing an application on a variety of networked and/or mobile computing platforms, a specific example of a mobile computing device where this technology may be applied will now be described. For example, an application or client shell can be tested that is running on a feature cell phone. The client shell for testing can be a comparatively small feature cell phone application which can be fast and easy to download and install. Further, the client shell may only be only one or two hundred kilobytes (KB) in size.

The single client shell can be compared to a web browser configured to execute a number of infrastructure components or embedded applets within the application. These embedded applets can be downloaded over a wireless network connection and users can access all of their mobile apps through one client shell. The client shell or application framework dynamically launches just the applets containing parts of an application that a user wants to use which can eliminate additional installation time and store the user's mobile apps on the user's phone. The infrastructure components can include embedded applets such as: a mobile wallet, Windows Live® Messenger, social networking, shopping, popular games, and multiple feed readers for sports, news, finance, and more. The applets are easier to find since users do not have to go to a website to get the applets because a directory of available applets may be presented in the client shell. In addition, the user's feature phone can present new applets and services without any need to download the applets, whenever the feature phone is on.

In one embodiment, the client shell to be regression tested may be a Java application that can be run on most feature phones that support Java. Software developers can then write new embedded applets for the client shell using existing tools and protocols like JavaScript and XML. This enables cell phone users to access mobile applets on feature phones and other similar mobile devices that have limited memory and processing capability. The client shell and applets may also access cloud computing services through a cell phone service network to help offload client shell and applet processing and storage from the feature phone to a cloud of internet processing devices, and this off-loading can improve the overall applet performance. The client shell is configured to run on a wide range of feature phones which is why the testing system and method are designed to be robust enough to test the same client shell and applets on hundreds of different hardware feature phones.

The testing technology described provides the ability to test an application using a single set of recorded testing macros, while validating many different mobile device types with the least cost. The described embodiments are useful in playing back macros on various types of mobile devices in order to test a specific application containing the dynamically loaded applets. However, the method can also be used for testing applications on netbooks, mobile devices, smart phones, laptops, and other network centric computing devices where an application can be executed on a wide variety of networked hardware.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for using synchronized event types in testing an application configured to be executed on multiple types of networked devices, comprising:
playing a macro containing recorded application events to be applied to the application for testing;
storing the recorded application events from the macro in a macro queue during playback;
identifying order independent events in the macro queue which precede an order dependent event, so as to remove identified order independent events received in any order from the macro queue;
identifying an order dependent event in the macro queue so as to remove the order dependent event identified in the macro queue after order independent events preceding the order dependent events have been removed; and
playing the order dependent event from the macro queue after the order dependent event has been removed from the macro queue.

2. The method as in claim 1, further comprising blocking the playback of the order dependent event until the order independent events are received to ensure a correct application state before the order dependent event is played back.

3. The method as in claim 1, wherein the step of identifying an order dependent event further comprises identifying an order dependent event that is a user-initiated event located at a head of the macro queue.

4. The method as in claim 3, further comprising playing back the user initiated event located at a head of the macro queue after order independent events have been removed.

5. The method as in claim 1, further comprising:
identifying an order dependent event that is a script execution event in the macro queue by searching through the macro queue beginning at the head of the macro queue;
removing the order independent events located ahead of the script execution event identified, the order dependent event being located in the body of the macro queue.

6. The method as in claim 1, wherein order independent events are non-user initiated events selected from the group consisting of: timer events, network events, and failure events, as received by a mobile networked device.

7. The method as in claim 1, wherein identifying order independent events further comprises:
removing timer events, failure events and network events from the macro queue when the timer events, failure events, and network events are received by a mobile networked device in any order as compared to an order of events in the macro queue.

8. The method as in claim 1, further comprising the step of recording a plurality of order independent events and order dependent events for the application in the macro.

9. The method as in claim 9, wherein recording a plurality of order independent events and order dependent events further comprises recording every event handled by event handlers on a networked device into the macro.

10. The method as in claim 1, further comprising the step of optimizing macro playback by discarding any order independent events that are non-user initiated events after a script synchronization event has been received.

11. The method as in claim 1, further comprising the step of optimizing the macro by removing events in the macro queue received from threads that do not affect the order dependent events.

12. The method as in claim 1, wherein an order independent event is a network event or hardware event on a networked device that does not involve user input.

13. The method as in claim 1, further comprising discarding events not matched to an event in the macro queue because an optimization stage or a synchronization event removed the event.

14. A system for testing an application in an application environment for a networked device, the system comprising:
a macro storage memory configured to store a macro, wherein recorded events are executable on a microprocessor on the networked device for testing the application;
a macro queue configured to store the recorded events from the macro during playback;
an event manager module configured to receive order independent events and order dependent events to be applied to the application; and
an event comparison module configured to identify order independent events which precede an order dependent event in the macro queue in order to enable removal of the received order independent events from the macro queue when order independent events are received by the network device;
wherein the event comparison module is further configured to identify an order dependent event in the macro queue in order to remove an order dependent event from the macro queue; and
an event playback module configured to playback the order dependent event after the order independent events have been removed.

15. The system as in claim 14, wherein the event recording module is configured to capture every event handled by an event handler on the networked device for storage in a macro.

16. The system as in claim 14, wherein the event comparison module is configured to identify an order dependent event that is a user-initiated event located at a head of the macro queue.

17. The system as in claim 14, wherein:
the event comparison module is configured to identify a first order dependent event that is located in a body of the macro queue;
the event comparison module is configured to remove the order dependent events preceding the identified order dependent event; and
a playback module is configured to playback the identified order independent event.

18. The system as in claim 14, wherein the event recording module is further configured to record a plurality of network events, user input events and script execution events into a macro for later playback.

19. A method for testing an application containing an application infrastructure configured to be executed on a plurality of feature cell phones types, comprising:
recording a plurality of events in a macro for regression testing of the application;
initiating playback of the macro containing the events;
storing recorded events from the macro in a macro queue during playback;
receiving non-user initiated events, user-initiated events, and script synchronization events configured to be applied to the application;
identifying non-user initiated events which precede a user-initiated event in the macro queue in order to discard the identified non-user initiated events from the macro queue as the non-user initiated events are received;
identifying whether a user-initiated event is at the head of the macro queue in order to remove the user-initiated event from the macro queue; and
playing a user-initiated event from the head of the macro queue after the user-initiated events have been removed from the macro queue.

20. The method as in claim 19, further comprising:
receiving the script synchronization event;
identifying whether a script synchronization event is in the macro queue by searching through the body of macro queue starting with the macro queue head in order to remove the script synchronization event from the macro queue; and
removing non-user initiated events before the script synchronization event.
